(19) United States
(12) Patent Application Publication
(10) Pub. No.: US 2009/0178375 A1
(43) Pub. Date: Jul. 16, 2009

(54) Stirrup for Harness and Method of Producing the Same

(75) Inventor: Mauro Benetti, Lonato (IT)

Correspondence Address: SHOEMAKER AND MATTARE, LTD, 10 POST OFFICE ROAD - SUITE 100, SILVER SPRING, MD, 20910, US

(73) Assignee: ACAVALLO S.R.L., Lonato (IT)

(21) Appl. No.: 12/369,972

(22) Filed: Feb. 12, 2009

(30) Foreign Application Priority Data
Jul. 16, 2007 (IT) BS2007A000021

(51) Int. Cl. B68C 3/00; B21D 53/00

(52) U.S. Cl. 54/49; 29/592

(57) ABSTRACT

A stirrup for a harness able to create a safe anchorage for footwear without damaging the sole of the said footwear. The stirrup guarantees anchorage of the sole in all conditions of use and is particularly easy to clean.

### FIELD OF THE INVENTION

The present invention relates to a stirrup, and specifically to one for the harnesses of horses used to provide a valid support for the rider's foot.

### BACKGROUND OF THE INVENTION

The stirrups comprise a stirrup body, generally of a ‘U’ shape, and a base positioned so as to connect with the branches of the stirrup body.

The body of the stirrup and the base form a lodging for footwear.

Specifically, a tread is joined to the base able to form a safe anchorage for the sole of the footwear.

State-of-the-art stirrups comprising treads are known of, usually in metal, comprising a number of ribs bent upwards from the opposite side of the support base.

The known state-of-the art solutions present numerous drawbacks in that they tend to rapidly ruin the soles of the footwear.

In fact, to improve the grip of the sole, the ribs are thin and sharp so as to penetrate at least partially the same sole. This way the sole is quickly damaged.

In addition in the known state-of-the art stirrups, if the foot is placed on the edge of the stirrup, often the ribs do not ensure a safe grip for the shoe which therefore tends to slip.

Lastly, the state-of-the-art stirrups tend to inevitably get covered in mud which obstructs and covers the ribs limiting the anchorage function to the sole of the footwear. The known state-of-the-art stirrups prove hard to remove the mud from.

### SUMMARY OF THE INVENTION

The aim of the present invention is to produce a stirrup which resolves the drawbacks mentioned with reference to the technical note.

Such drawbacks and limitations are resolved by a stirrup in accordance with claim 1.

Other forms of embodiment of the stirrup according to the invention are described in the subsequent claims.

### BRIEF DESCRIPTION OF THE DRAWINGS

Further characteristics and advantages of the present invention will be evident from the description below, made by way of an indicative and non-limiting example of its preferred embodiments, wherein:

FIG. 1 shows a perspective view of a stirrup according to a form of embodiment of the present invention;

FIG. 2 shows a perspective view in separate parts of the stirrup in FIG. 1;

FIG. 3 shows a perspective view of an enlarged detail of the stirrup in FIG. 1;

FIG. 4 shows a plan view of an enlarged detail of the stirrup in FIG. 1.

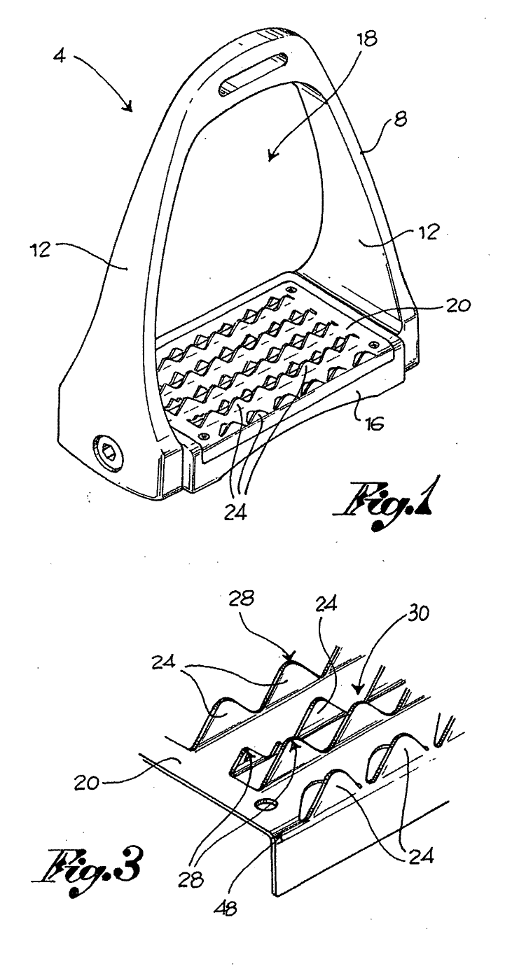

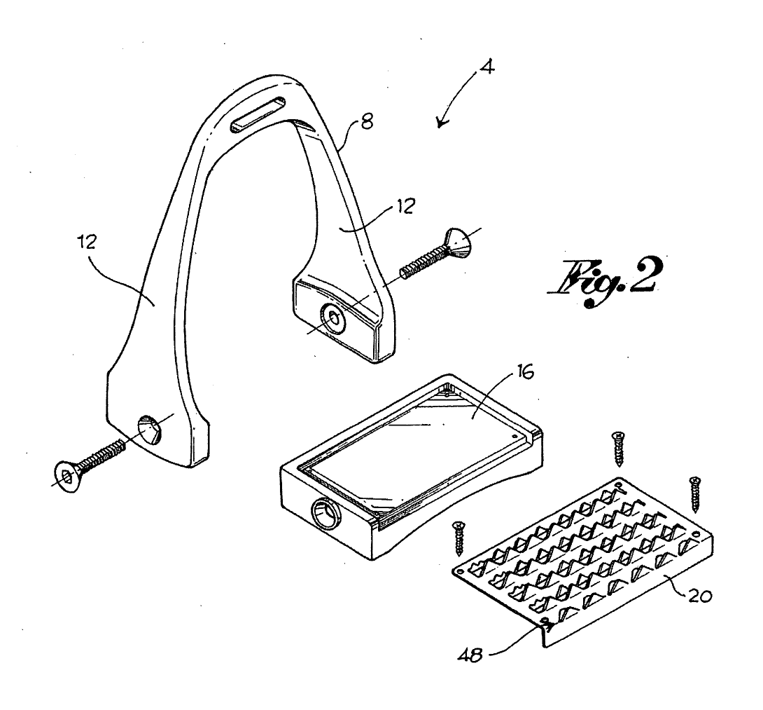

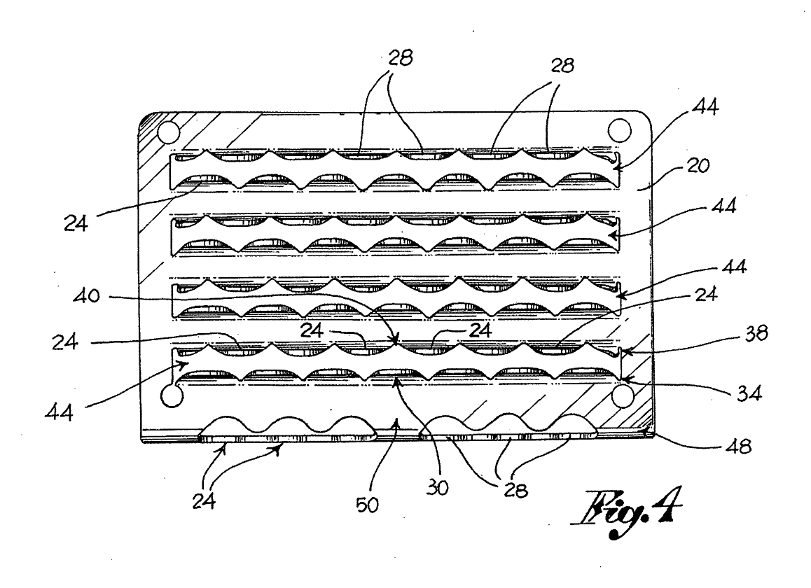

The elements or parts of elements common to the forms of embodiment described below will be denoted by the same reference numeral.

### DETAILED DESCRIPTION OF THE INVENTION

With reference to the aforesaid figures, reference numeral 4 globally denotes a stirrup for harnesses.

The stirrup 4 comprises a stirrup body 8, having a pair of branches 12 positioned in a ‘U’ configuration and comprising a base 16 positioned so as to connect the branches 12 of the body of the stirrup 8, so that the stirrup body 8 and the base 16 form a seat 18 for footwear.

The stirrup 4 comprises a tread 20, joined to said base 16 and able to provide a safe anchorage for the sole of the footwear.

Advantageously, said tread 20 comprises a number of ribs 24 bent upwards on the opposite side of the base 16 so as to constitute a blocking element for the sole of the footwear.

Preferably, said ribs are of an essentially triangular shape.

According to one form of embodiment, said triangular profile comprises a curved connection portion 28 at the apex 30 of said profile.

According to one form of embodiment, the ribs 24 are aligned with each other and arranged at least in a first row 34, extending in a transverse direction, essentially perpendicular to said branches 12 of the body of the stirrup 8.

According to one form of embodiment, the ribs 24 are arranged in at least a first and second row 34,38 and are staggered from each other so that the apex 30 of a first row 34 is aligned with a connection groove 40 between two consecutive ribs 24 of the second row of ribs 38.

Preferably, said first and second rows of ribs 34,38 are parallel to each other.

Preferably, the ribs 24 of the single rows of the tread are the same as each other and arranged with a uniform spacing.

Advantageously, at least two rows 34,38 of consecutive ribs 24 form a window 44 on said tread 20, able to facilitate the removal of mud between said ribs.

Advantageously, said tread 20 comprises at least one rib 24 at one edge 48 of the tread 20 facing the footwear.

Preferably, the tread 20 comprises a number of ribs 24 aligned in series with each other, at said edge 48 of the tread.

According to one form of embodiment, the ribs 24 are aligned parallel to said edge 48.

According to one form of embodiment, the series of ribs 24 positioned on the edge 48 is interrupted at a joint portion 50.

Preferably, the joint portion 50 is positioned at the middle portion of the edge 48, in relation to the branches 12 of the ‘U’ portion.

According to one form of embodiment, the ribs 24 are essentially perpendicular to said base 16.

According to a further form of embodiment, the ribs 24 of two adjacent rows 34,38 converge with each other, on the opposite side to the associable base 16.

The method of producing a stirrup according to the present invention comprises the phase of organizing the incision of a plate able to form the tread 20 of the stirrup 4, so that said incision has a sinusoidal profile.

For example the incision may be performed by laser or by a slicing machine.

In addition, the method comprises the phase of bending back the portions of incision of the tread 20 towards the opposite side of the associable tread 20, so as to form the ribs blocking the sole.

As may be appreciated from the description, the stirrup according to the present invention overcomes the drawbacks presented in the technical note.

In fact, the special conformation of the tread permits safe anchorage of the sole without ruining the sole of the footwear.

In addition, thanks to the presence of a row of ribs at the edge of the tread, a perfect anchorage of the sole is ensured even when the sole of the footwear is placed on the very edge of the same without risk that the foot might slip.

Furthermore, thanks to the configuration of the ribs which form continuous channels, the removal of surplus mud is particularly easy and may be performed simply by beating the stirrup against an obstacle.

A technician skilled in this area, may make numerous modifications and adjustments to the stirrups described above so as to satisfy contingent and specific requirements, all contained within the sphere of the invention as defined by the following claims.

I claim:

1. Stirrup comprising
a stirrup body, having a pair of branches in a ‘U’ shaped configuration,
a base positioned in connection with the branches of the stirrup body and the base forming a lodging for the footwear,
a tread, joined to said base and able to form a safe anchorage for the sole of the footwear,
wherein said tread comprises a number of ribs bent in the opposite direction to the base so as to constitute a blocking element for the sole of the footwear,
said ribs having an essentially triangular profile.

2. Stirrup according to claim 1, wherein said triangular profile comprises a curved connection portion at the apex of said profile.

3. Stirrup according to claim 1, wherein said ribs are aligned with each other and arranged at least in a first row, extending in a transverse direction, essentially perpendicular to said branches of the stirrup body.

4. Stirrup according to claim 1, wherein said ribs are arranged in at least a first and second row and are staggered from each other along said transverse direction so that the apex of a rib of a first row is aligned with a connection groove between two consecutive ribs of the second row of ribs.

5. Stirrup according to claim 4, wherein said first and second rows of ribs are parallel to each other.

6. Stirrup according to claim 4, wherein the ribs of separate rows of the tread are the same as each other and are arranged with the same spacing between them.

7. Stirrup according to claim 4, wherein at least two consecutive rows of ribs form a window on said tread, able to facilitate the removal of mud between said ribs.

8. Stirrup according to claim 1, wherein said tread comprises at least one rib on the edge of the tread facing the footwear.

9. Stirrup according to claim 1, wherein the tread comprises a number of ribs aligned in series with each other, at said edge of the tread.

10. Stirrup according to claim 9, wherein said ribs are aligned parallel to said edge.

11. Stirrup according to claim 9, wherein the series of ribs positioned on the edge is interrupted at a joint portion.

12. Stirrup according to claim 11, wherein said joint portion is positioned at the middle portion of the edge, in relation to the branches of the ‘U’ portion.

13. Stirrup according to claim 1, wherein said ribs are essentially perpendicular to said base.

14. Stirrup according to claim 1, wherein the ribs of two adjacent rows essentially converge with each other, on the side opposite the associable base.

15. Method of production of a stirrup according to claim 1, comprising the phase of organizing the incision of a plate able to form the tread of the stirrup, said incision having a sinusoidal profile.

16. Method of production of a stirrup according to claim 15, wherein said incision is performed by using a laser.

17. Method of production of a stirrup according to claim 15, wherein said incision is performed by using a slicing machine.

18. Method of production of a stirrup according to claim 15 comprising the phase of bending back the portions of incision of the tread towards the opposite side of the associable tread, so as to form the ribs blocking the sole.
